(19) United States
(12) Patent Application Publication
(10) Pub. No.: US 2025/0031201 A1
(43) Pub. Date: Jan. 23, 2025

(54) LONG-TERM EVOLUTION AND NEW RADIO SIDELINK CO-CHANNEL COEXISTENCE

(71) Applicant: QUALCOMM Incorporated, San Diego, CA (US)

(72) Inventors: Sourjya DUTTA, San Diego, CA (US); Tien Viet NGUYEN, Bridgewater, NJ (US); Shijun WU, San Diego, CA (US); Hui GUO, Beijing (CN); Gabi SARKIS, San Diego, CA (US); Kapil GULATI, Belle Mead, NJ (US); Arthur GUBESKYS, San Diego, CA (US)

(21) Appl. No.: 18/714,754

(22) PCT Filed: Jan. 19, 2022
(86) PCT No.: PCT/CN2022/072664

§ 371 Date: May 30, 2024

(51) Int. Cl. H04W 72/12; H04W 72/02; H04W 72/25; H04W 72/40; H04W 88/06

(52) U.S. Cl. CPC H04W 72/1215; H04W 72/02; H04W 72/25; H04W 72/40; H04W 88/06

(57) ABSTRACT

Methods, systems, and devices for wireless communications are described. A first user equipment (UE) and a base station may establish communications using a first radio access technology (RAT). The first UE may receive control signaling indicating a configuration for a coexistence of resources between the first RAT and a second RAT, the coexistence of resources indicating an initial quantity of UEs in a system that use the first RAT or the second RAT. During a measurement period, the first UE may measure a control channel (e.g., a sidelink control channel) of the second RAT and determine an initial partition of the resources. The initial partition of the resources may indicate a quantity of resources to be used for transmissions by the first UE and the second UE. For example, a first group of the initial partition of the resources may be associated with the second RAT.

### CROSS REFERENCE

The present application is a 371 national phase filing of International PCT Application No. PCT/CN2022/072664 by DUTTA et al., entitled “LONG-TERM EVOLUTION AND NEW RADIO SIDELINK CO-CHANNEL COEXISTENCE,” filed Jan. 19, 2022, which is assigned to the assignee hereof, and which is expressly incorporated by reference in its entirety herein.

### FIELD OF TECHNOLOGY

The following relates to wireless communications, including Long-Term Evolution (LTE) and New Radio (NR) sidelink co-channel coexistence.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support Long-Term Evolution (LTE) and New Radio (NR) (e.g., fifth generation (5G) NR) sidelink co-channel coexistence. Generally, the described techniques provide for a first user equipment (UE) to partition resources from a common resource pool for its use based on a determination of resources that may be used by a second UE. In some examples, the first UE may operate using a first radio access technology (RAT) (e.g., 5G NR) and the second UE may operate using a second RAT (e.g., LTE). The first UE may establish communications with a base station and receive control signaling indicating a configuration for a coexistence of resources for the first RAT and the second RAT. In some examples, the control signaling may indicate a configuration for a coexistence of resources that may already be preconfigured at the first UE. The configuration for the coexistence of resources may indicate an initial estimate of how many UEs initially in a wireless communications system are operating using the first RAT or the second RAT.

During a first measurement period, the first UE, operating using the first RAT, may measure a sidelink control channel (e.g., an LTE sidelink control channel) associated with the second RAT to determine an initial partition of the resources (e.g., a resource pool partition frame structure), which may indicate how many resources in a resource pool may be allocated for NR communications by the first UE or LTE communications by the second UE. For example, a first group of the initial partition of the resources may be allocated for the second RAT, and a second group of the initial partition of the resources may be allocated for the first RAT. Additionally or alternatively, the first UE may update the partition of resources during multiple update periods after the measurement period. For example, during an update period, the first UE may recalculate how many UEs in the wireless communications system are operating using the first RAT or the second RAT (e.g., a penetration rate, a channel occupancy), and the first UE may determine an updated partition of the resources based on the recalculated quantity of UEs using each RAT. As such, the described techniques may enable multiple UEs using different RATs to communicate in the same channel based on the decoding of a sidelink control channel corresponding to a particular RAT (e.g., LTE).

A method for wireless communication at a UE is described. The method may include receiving, from a base station, control signaling including an indication of a configuration for a coexistence of resources used for a first RAT and a second RAT, where the UE operates in accordance with the first RAT, performing, during a measurement period, a measurement of a control channel of the second RAT in response to the receiving, and determining an initial partition of the resources based on the configuration and the measurement, where a first group of the initial partition of the resources is associated with the second RAT.

An apparatus for wireless communication at a UE is described. The apparatus may include a processor, memory coupled with the processor, and instructions stored in the memory. The instructions may be executable by the processor to cause the apparatus to receive, from a base station, control signaling including an indication of a configuration for a coexistence of resources used for a first RAT and a second RAT, where the UE operates in accordance with the first RAT, perform, during a measurement period, a measurement of a control channel of the second RAT in response to the receiving, and determine an initial partition of the resources based on the configuration and the measurement, where a first group of the initial partition of the resources is associated with the second RAT.

Another apparatus for wireless communication at a UE is described. The apparatus may include means for receiving, from a base station, control signaling including an indication of a configuration for a coexistence of resources used for a first RAT and a second RAT, where the UE operates in accordance with the first RAT, means for performing, during a measurement period, a measurement of a control channel of the second RAT in response to the receiving, and means for determining an initial partition of the resources based on the configuration and the measurement, where a first group of the initial partition of the resources is associated with the second RAT.

A non-transitory computer-readable medium storing code for wireless communication at a UE is described. The code may include instructions executable by a processor to receive, from a base station, control signaling including an indication of a configuration for a coexistence of resources used for a first RAT and a second RAT, where the UE operates in accordance with the first RAT, perform, during a measurement period, a measurement of a control channel of the second RAT in response to the receiving, and determine an initial partition of the resources based on the configuration and the measurement, where a first group of the initial partition of the resources is associated with the second RAT.

Some examples of the method, apparatuses, and non-transitory computer-readable medium described herein may further include operations, features, means, or instructions for decoding a set of multiple sidelink scheduling assignments associated with the second RAT during the measurement period and determining an updated partition of the resources based on the decoding.

Some examples of the method, apparatuses, and non-transitory computer-readable medium described herein may further include operations, features, means, or instructions for determining a first quantity of resources reserved for a first transmission of a set of multiple transmissions, a second quantity of resources reserved for a future transmission of the set of multiple transmissions, a priority of the set of multiple transmissions, a reference signal received power (RSRP) associated with the control channel of the second RAT, or any combination thereof and determining the updated partition of the resources based on the determining.

In some examples of the method, apparatuses, and non-transitory computer-readable medium described herein, the future transmission includes a retransmission of the first transmission of the set of multiple transmissions or semi-persistent scheduling (SPS) resource signaling.

Some examples of the method, apparatuses, and non-transitory computer-readable medium described herein may further include operations, features, means, or instructions for filtering the set of multiple sidelink scheduling assignments based on the RSRP associated with the control channel of the second RAT, the priority of the set of multiple transmissions, or any combination thereof.

In some examples of the method, apparatuses, and non-transitory computer-readable medium described herein, receiving the control signaling may include operations, features, means, or instructions for receiving the control signaling including an indication of the measurement period, a set of multiple update periods after the measurement period, or a combination thereof.

Some examples of the method, apparatuses, and non-transitory computer-readable medium described herein may further include operations, features, means, or instructions for determining an updated partition of the resources according to a first update period of the set of multiple update periods after the measurement period, where the updated partition of the resources may be different from the initial partition of the resources.

In some examples of the method, apparatuses, and non-transitory computer-readable medium described herein, receiving the control signaling may include operations, features, means, or instructions for receiving the control signaling indicating at least one criterion for determining the initial partition of the resources by the UE.

Some examples of the method, apparatuses, and non-transitory computer-readable medium described herein may further include operations, features, means, or instructions for determining at least one criterion for determining the initial partition of the resources based on a signaling traffic pattern, a transmission statistic, or any combination thereof.

Some examples of the method, apparatuses, and non-transitory computer-readable medium described herein may further include operations, features, means, or instructions for determining a second group of the initial partition of the resources that may be associated with the first RAT based on receiving the control signaling.

In some examples of the method, apparatuses, and non-transitory computer-readable medium described herein, receiving the control signaling may include operations, features, means, or instructions for receiving the control signaling including an indication of the second group of the initial partition of the resources that may be associated with the first RAT.

In some examples of the method, apparatuses, and non-transitory computer-readable medium described herein, the control channel of the second RAT includes a sidelink control channel.

In some examples of the method, apparatuses, and non-transitory computer-readable medium described herein, the first RAT includes 5G NR and the second RAT includes LTE.

A method for wireless communication at a base station is described. The method may include establishing communications with a UE using a first RAT and transmitting, to the UE, control signaling including an indication of a configuration for a coexistence of resources used for the first RAT and a second RAT, where the UE operates in accordance with the first RAT.

An apparatus for wireless communication at a base station is described. The apparatus may include a processor, memory coupled with the processor, and instructions stored in the memory. The instructions may be executable by the processor to cause the apparatus to establish communications with a UE using a first RAT and transmit, to the UE, control signaling including an indication of a configuration for a coexistence of resources used for the first RAT and a second RAT, where the UE operates in accordance with the first RAT.

Another apparatus for wireless communication at a base station is described. The apparatus may include means for establishing communications with a UE using a first RAT and means for transmitting, to the UE, control signaling including an indication of a configuration for a coexistence of resources used for the first RAT and a second RAT, where the UE operates in accordance with the first RAT.

A non-transitory computer-readable medium storing code for wireless communication at a base station is described. The code may include instructions executable by a processor to establish communications with a UE using a first RAT and transmit, to the UE, control signaling including an indication of a configuration for a coexistence of resources used for the first RAT and a second RAT, where the UE operates in accordance with the first RAT.

In some examples of the method, apparatuses, and non-transitory computer-readable medium described herein, transmitting the control signaling may include operations, features, means, or instructions for transmitting the control signaling including an indication of a measurement period, a set of multiple update periods after the measurement period, or a combination thereof.

In some examples of the method, apparatuses, and non-transitory computer-readable medium described herein, transmitting the control signaling may include operations, features, means, or instructions for transmitting the control signaling indicating at least one criterion for determining an initial partition of the resources by the UE.

In some examples of the method, apparatuses, and non-transitory computer-readable medium described herein, transmitting the control signaling may include operations, features, means, or instructions for transmitting the control signaling including an indication of a first group of an initial partition of the resources associated with the second RAT and a second group of the initial partition of the resources associated with the first RAT.

In some examples of the method, apparatuses, and non-transitory computer-readable medium described herein, the first RAT includes 5G NR and the second RAT includes LTE.

### BRIEF DESCRIPTION OF THE DRAWINGS

FIG. 1 illustrates an example of a wireless communications system that supports Long-Term Evolution (LTE) and New Radio (NR) sidelink co-channel coexistence in accordance with aspects of the present disclosure.

FIG. 2 illustrates an example of a wireless communications system that supports LTE and NR sidelink co-channel coexistence in accordance with aspects of the present disclosure.

FIG. 3 illustrates an example of a timeline that supports LTE and NR sidelink co-channel coexistence in accordance with aspects of the present disclosure.

FIG. 4 illustrates an example of a set of resource pool partition frame structures that supports LTE and NR sidelink co-channel coexistence in accordance with aspects of the present disclosure.

FIG. 5 illustrates an example of a process flow that supports LTE and NR sidelink co-channel coexistence in accordance with aspects of the present disclosure.

FIGS. 6 and 7 show block diagrams of devices that support LTE and NR sidelink co-channel coexistence in accordance with aspects of the present disclosure.

FIG. 8 shows a block diagram of a communications manager that supports LTE and NR sidelink co-channel coexistence in accordance with aspects of the present disclosure.

FIG. 9 shows a diagram of a system including a device that supports LTE and NR sidelink co-channel coexistence in accordance with aspects of the present disclosure.

FIGS. 10 and 11 show block diagrams of devices that support LTE and NR sidelink co-channel coexistence in accordance with aspects of the present disclosure.

FIG. 12 shows a block diagram of a communications manager that supports LTE and NR sidelink co-channel coexistence in accordance with aspects of the present disclosure.

FIG. 13 shows a diagram of a system including a device that supports LTE and NR sidelink co-channel coexistence in accordance with aspects of the present disclosure.

FIGS. 14 through 19 show flowcharts illustrating methods that support LTE and NR sidelink co-channel coexistence in accordance with aspects of the present disclosure.

### DETAILED DESCRIPTION

In some examples, fifth generation (5G) New Radio (NR) systems and Long-Term-Evolution (LTE) systems (e.g., or any other radio access technologies (RATs) may operate in a same channel. In some cases, if there is a lack of coordination between NR (e.g., 5G NR) and LTE sidelink communications, NR and LTE transmissions may occupy the same time and frequency resources and collide, degrading performance of user equipments (UE) in the NR and LTE systems. In some examples, NR and LTE transmissions may be coordinated using a resource pool frame structure, in which a channel (e.g., over a fixed time) may be partitioned into a first set of time intervals (e.g., slots, subframes) allocated for NR transmissions and a second set of time intervals allocated for LTE transmissions. However, the RATs and any UEs in the system may fail to agree on the resource partitions (e.g., a resource pool frame structure), which may cause decrease resource efficiency. In addition, if more or fewer UEs using NR or LTE enter the system, or if traffic loads change over NR or LTE, the resource partitions may evolve over time in response to the changes. Without adapting to the changing system, UEs may experience collisions, failed transmissions, and overall performance degradation.

Techniques described herein enable LTE and NR (e.g., 5G NR) sidelink co-channel coexistence in a distributed sidelink wireless communications system, where a first UE may partition resources from a common resource pool for its use based on a determination of resources that may be used by a second UE. In some examples, the first UE may operate using a first RAT (e.g., 5G NR) and the second UE may operate using a second RAT (e.g., LTE). The first UE may establish communications with a base station and receive control signaling indicating a configuration for a coexistence of resources for the first RAT and the second RAT. In some examples, the control signaling may indicate a configuration for a coexistence of resources that may already be preconfigured at the first UE. The configuration for the coexistence of resources may indicate an initial estimate of how many UEs initially in a wireless communications system are operating using the first RAT or the second RAT.

During a first measurement period, the first UE, operating using the first RAT, may measure a sidelink control channel (e.g., an LTE sidelink control channel) associated with the second RAT to determine an initial partition of the resources (e.g., a resource pool partition frame structure), which may indicate how many resources in a resource pool may be allocated for NR communications by the first UE or LTE communications by the second UE. For example, a first group of the initial partition of the resources may be allocated for the second RAT, and a second group of the initial partition of the resources may be allocated for the first RAT. Additionally or alternatively, the first UE may update the partition of resources during multiple update periods after the measurement period. For example, during an update period, the first UE may recalculate how many UEs in the wireless communications system are operating using the first RAT or the second RAT (e.g., a penetration rate, a channel occupancy), and the first UE may determine an updated partition of the resources based on the recalculated quantity of UEs using each RAT. As such, the described techniques may enable multiple UEs using different RATs to communicate in the same channel based on the decoding of a sidelink control channel corresponding to a particular RAT (e.g., LTE).

Aspects of the disclosure are initially described in the context of wireless communications systems. Aspects of the disclosure are then described in the context of timelines, resource pool partition frame structures, and process flows. Aspects of the disclosure are further illustrated by and described with reference to apparatus diagrams, system diagrams, and flowcharts that relate to LTE and NR sidelink co-channel coexistence.

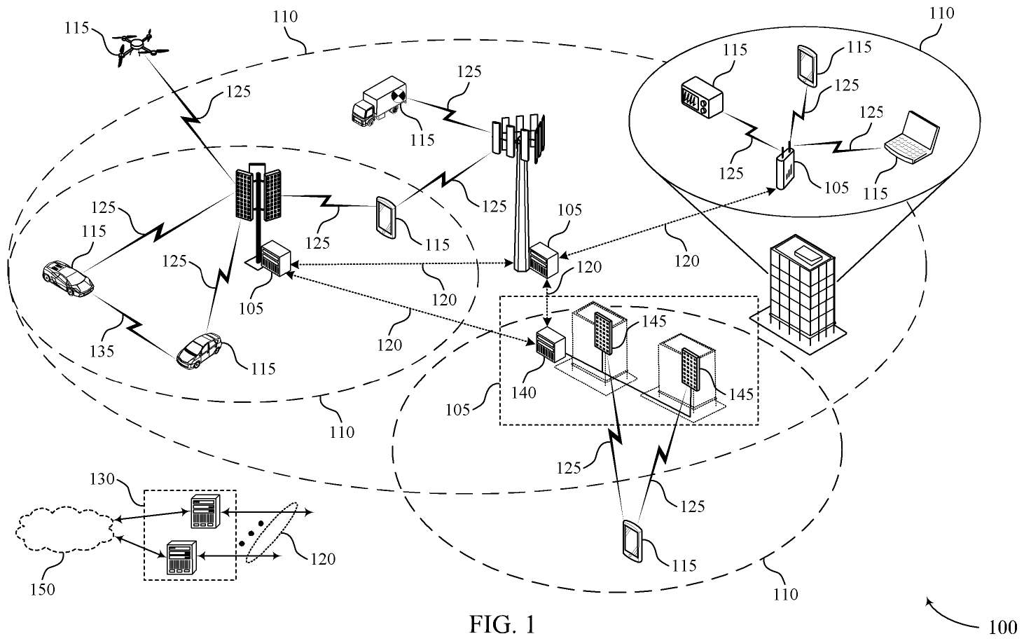

FIG. 1 illustrates an example of a wireless communications system 100 that supports LTE and NR sidelink co-channel coexistence in accordance with aspects of the present disclosure. The wireless communications system 100 may include one or more base stations 105, one or more UEs 115, and a core network 130. In some examples, the wireless communications system 100 may be an LTE network, an LTE-Advanced (LTE-A) network, an LTE-A Pro network, or an NR network (e.g., a 5G NR network). In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (RAT) (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different RAT).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular RAT (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) RAT, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some examples, a shortage of spectrum may cause NR (e.g., 5G NR) and LTE sidelink communications (e.g., 5G NR V2X and LTE V2X communications) to operate in a same channel, band, or both. In the absence of a coordination mechanism, NR and LTE transmissions may occupy same time and frequency resources, collide, and degrade UE performance. Additionally or alternatively, an NR device (e.g., a wireless device operating using 5G NR V2X communications) may be a dual-radio device, which may transmit basic safety message (BSM) packets, cooperative awareness message (CAM) packets, sensor sharing, or other traffic. In some cases, these transmissions may conflict with LTE communications (e.g., LTE V2X communications) in the same channel.

In some examples, NR and LTE transmissions may be coordinated using a resource pool frame structure, in which a channel may be partitioned over a fixed time into a first set of time intervals (e.g., slots, subframes) allocated for NR transmissions and a second set of time intervals allocated for LTE transmissions. That is, an NR device may access a channel in a first time partition, and an LTE device (e.g., a wireless device operating using LTE V2X communications) may access the same channel in a different time partition. However, the RATs and any UEs 115 in the system may fail to agree on the resource pool frame structure, which may decrease resource efficiency. In addition, if more or fewer UEs 115 using NR or LTE enter the system, the resource pool frame structure may evolve over time in response to the changes. For example, during an initial phase of 5G NR V2X deployment, a system may include more UEs 115 using LTE than NR. As several years pass, more wireless devices using NR may be deployed in the system, and more UEs using LTE may be phased out. As such, the quantity of NR devices in the system (e.g., an NR penetration rate) may increase and the resource pool frame structure may evolve to account for this change. In another example, the resource pool frame structure may adapt to geographic changes. For example, an NR V2X device (e.g., a vehicle) may move along a highway using NR and then exit into a dense environment with many more LTE V2X devices. The resource pool frame structure may change based on how many LTE V2X devices may now be in the wireless communications system. As such, the resource pool frame structure at each V2X device in the system may adapt to changing NR penetration rates.

Additionally or alternatively, the resource pool frame structure may change based on changes in traffic loads over NR or LTE. For example, a system may have a fixed NR traffic pattern, or may support mission critical NR transmissions in which data rates fluctuate. As such, the resource pool frame structure may adapt to account for variations in NR and LTE traffic. Moreover, an LTE device may refrain from changing its resource usage in response to the changes to traffic and penetration rates, and as such, NR devices may solely respond to the changes to avoid collisions with LTE transmissions.

For NR and LTE transmissions to co-exist in a channel, some resource partition between NR and LTE may be employed. In some examples, an available bandwidth between NR and LTE may be partitioned, however a bandwidth partition may fail to adapt to network conditions. For example, if there are more wireless devices (e.g., UEs 115) using LTE than NR in a system, then an equal partition of the available bandwidth between LTE and NR may degrade LTE performance. In addition, if there are more wireless devices using NR than LTE, an equal or fixed partition of the available bandwidth may prevent a wireless device using NR from using available radio resources for advanced traffic.

Additionally or alternatively, a sidelink LTE device may perform a received signal strength indicator (RSSI) based ranking of available resources and refrain from using resources which have a high measured RSSI. In some examples, an NR device may estimate a ratio of NR devices to LTE devices in a system (e.g., using different techniques), and based on the ratio, the NR device may determine a resource pool frame structure and a partition of resources for the NR device and the LTE device. An NR wireless device may transmit using the resources determined for use by the NR device and skip the resources determined for use by the LTE device. In some cases, a resource pool frame structure may be determined based on an NR penetration rate. An NR penetration rate may represent a portion of UEs in a system that operate using NR. In some examples, the NR penetration rate may be determined by an indication in LTE sidelink control information (SCI), in a MAC control element (MAC-CE) which may indicate whether a device uses NR or LTE, in a MAC-CE where the presence of the indication may imply dual radio (e.g., NR and LTE) capability, or by an absence of the indication, which may imply LTE only UEs (e.g., low to no NR penetration rate). In another example, a device may estimate an NR penetration rate using a channel busy ratio (CBR) or other congestion metric, or using control and data decoding for both NR and LTE. Each NR device may adjust the resource pool frame structure based on a latest average penetration rate estimation. Additionally or alternatively, LTE and NR resources may be time domain multiplexed (TDMed) on different slots or frequency division multiplexed (FDMed) in the same slot. In some cases, the resource pool frame structure may include physical sidelink feedback channel (PSFCH) resources for NR sidelink communications.

However, determining the resource pool frame structure based on the NR penetration rate may fail to account for the quantity of LTE devices in the system and exclude resources from a resource pool that may be used by an LTE UE. In addition, determining the resource pool frame structure by counting the quantity of NR devices and LTE devices in a system may fail to account for changes to NR and LTE traffic loads and lead to suboptimal resource partitions.

The wireless communications system 100 supports techniques for LTE and NR (e.g., 5G NR) sidelink co-channel coexistence, where a first UE 115 (e.g., a UE 115 operating in accordance with 5G NR) may partition resources from a resource pool for use by a second UE 115 (e.g., a UE 115 operating in accordance with LTE). In some examples, the first UE 115 may operate using a first RAT (e.g., 5G NR) and the second UE 115 may operate using a second RAT (e.g., LTE). The first UE 115 may establish communications with a base station 105 and receive control signaling indicating a configuration for a coexistence of resources for the first RAT and the second RAT. In some examples, the control signaling may indicate a configuration for a coexistence of resources that may already be preconfigured at the first UE 115. The configuration for the coexistence of resources may indicate an initial estimate of how many UEs 115 in the wireless communications system 100 are operating using the first RAT or the second RAT.

During a first measurement period, the first UE 115, operating using the first RAT (e.g., 5G NR) may measure a sidelink control channel associated with the second RAT (e.g., an LTE sidelink control channel) to determine an initial partition of the resources (e.g., a resource pool partition frame structure), which may indicate how many resources in a resource pool may be allocated for NR communications by the first UE 115 or LTE communications by the second UE 115. For example, a first group of the initial partition of the resources designated for the second RAT, and a second group of the initial partition of the resources may be allocated for the first RAT. Additionally or alternatively, the first UE 115 may update the partition of resources during multiple update periods after the measurement period. For example, during an update period, the first UE 115 may recalculate how many UEs 115 in the wireless communications system 100 are operating using the first RAT or the second RAT (e.g., a penetration rate), and the first UE 115 may determine the updated partition of the resources based on the updated quantity of UEs 115 using each RAT. As such, the described techniques may enable multiple UEs 115 using different RATs to communicate in the same channel based on the decoding of a sidelink control channel corresponding to a particular RAT (e.g., LTE).

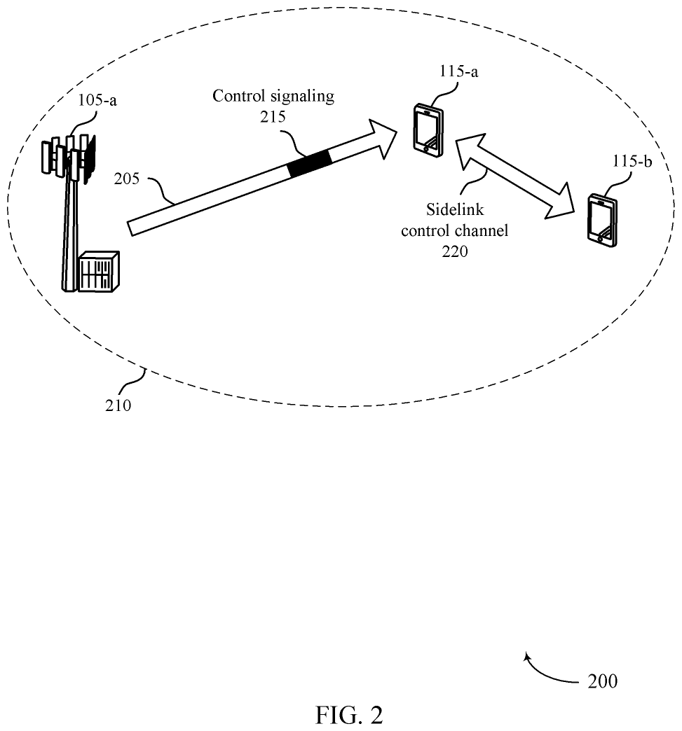

FIG. 2 illustrates an example of a wireless communications system 200 that supports LTE and NR sidelink co-channel coexistence in accordance with aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, and a base station 105-a, which may be examples of corresponding devices described herein. In some examples, the UE 115-a may operate using a first RAT (e.g., 5G NR, 5G NR V2X communications) and the UE 115-b may operate using a second RAT (e.g., LTE, LTE V2X communications).

In some cases, the UE 115-a and the UE 115-b (e.g., and any other wireless devices in the wireless communications system 200) may communicate via an uplink, a downlink, a sidelink, or any combination thereof. For example, the UE 115-a may communicate with the base station 105-a via a communications link 205 (e.g., a downlink), and in some examples, may also communicate with the base station 105-a via a downlink (e.g., Uu communications). UEs 115 may communicate with other UEs 115 over sidelink channels, by transmitting and receiving sidelink messages. For example, the UE 115-a and the UE 115-b may communicate sidelink messages via a sidelink control channel 220. UEs 115 capable of sidelink communications may communicate with other UEs 115 (e.g., C-UEs), vehicle UEs (V-UEs), road-side units (RSUs), smart devices, or wearable devices (e.g., smart watches, smart glasses, or earbuds).

The wireless communications system 200 (e.g., a distributed sidelink wireless communications system) may support LTE and NR (e.g., 5G NR) sidelink co-channel coexistence. For example, the UE 115-a (e.g., a UE 115 that operates in accordance with 5G NR) and the UE 115-b (e.g., a UE 115 that operates in accordance with LTE) may coexist in a same channel or band based on the UE 115-a decoding the sidelink control channel 220 (e.g., an LTE sidelink control channel). The UE 115-a may determine a partition of resources to be used by the UE 115-a for NR communications and the UE 115-b for LTE communications based on decoding the sidelink control channel 220, which may be a function of LTE traffic loads in addition to the quantity of UEs 115 in the wireless communications system 200 that operate using either NR or LTE.

The base station 105-a may establish wireless communications with the UE 115-a via the communications link 205 within a coverage area 210. The coverage area 210 may be an example of a geographic area over which the base station 105-a, the UE 115-a, and the UE 115-b may support the communications according to one or more RATs (e.g., 5G NR, LTE, or other RATs). In some examples, the UE 115-a may be configured or preconfigured for co-channel operation with the UE 115-b. For example, the UE 115-a may receive control signaling 215 from the base station 105-a, where the control signaling 215 may indicate a configuration for a coexistence of resources used for a first RAT (e.g., NR) and a second RAT (e.g., LTE). The indication may include the configuration for the coexistence of resources that the UE 115-a receives from the base station 105-a, or the indication may include a configuration for a coexistence of resources that is already preconfigured at the UE 115-a. In some cases, the configuration for the coexistence of resources may indicate an initial estimate of how many UEs 115 in the wireless communications system 200 operate in accordance with 5G or LTE (e.g., a device count).

During a measurement period (e.g., To), the UE 115-a may measure the sidelink control channel 220 of the second RAT (e.g., an LTE sidelink control channel) in response to receiving the control signaling 215. By measuring the sidelink control channel 220, the UE 115-a may measure LTE traffic or other congestion-based metrics over the sidelink control channel 220. In some examples, the UE 115-a may determine an initial penetration of the resources (e.g., an initial resource pool partition frame structure) based on the control signaling 215 and the measurement of the sidelink control channel 220, where the initial partition of the resources may indicate how many resources in a resource pool may be allocated for use by the UE 115-a for NR communications or by the UE 115-b for LTE communications. For example, a first group of the initial partition of the resources may be associated with the second RAT, and a second group of the initial partition of the resources may be associated with the second RAT. As such, the UE 115-a may determine the initial partition of the resources based on the quantity of NR UEs and LTE UEs in the wireless communications system 200 (e.g., an NR penetration rate and an LTE penetration rate) and LTE traffic loads in the wireless communications system 200 (e.g., the measured sidelink control channel 220), which may enable increased resource efficiency and improved UE performance.

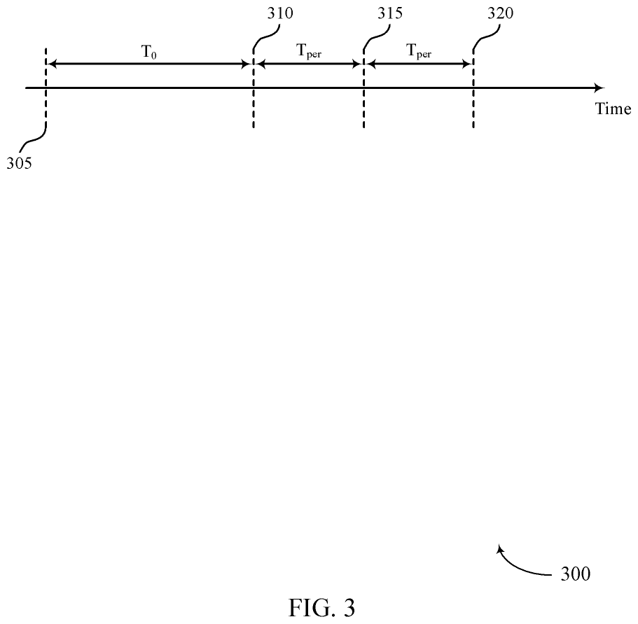

FIG. 3 illustrates an example of a timeline 300 that supports LTE and NR sidelink co-channel coexistence in accordance with aspects of the present disclosure. In some examples, the timeline 300 may implement aspects of the wireless communications systems 100 and 200 or may be implemented by aspects of the wireless communications systems 100 and 200. For example, a first UE that operates in accordance with a first RAT (e.g., 5G NR) may decode a sidelink control channel corresponding to a second RAT (e.g., an LTE sidelink control channel)) to determine a resource pool partition frame structure that enables sidelink co-channel coexistence for the first UE and a second UE that operates in accordance with the second RAT (e.g., LTE).

As described with reference to FIG. 2, the first UE may determine a resource pool partition frame structure that enables NR communications for the first UE and LTE communications for the second UE in a same channel or band. The resource pool partition frame structure may indicate particular resources in a resource pool that may be used by the first UE or the second UE such that NR and LTE transmissions may refrain from colliding in the same channel. After establishing communications with a base station, at 305, the first UE may receive control signaling from the base station indicating a configuration for a coexistence of resources used for a first RAT (e.g., 5G NR) and a second RAT (e.g., LTE). In some examples, the configuration for the coexistence of resources may be preconfigured at the first UE (e.g., via RRC signaling). The configuration for the coexistence of resources may include an initial penetration rate estimate (e.g., R₀), which may indicate how many NR UEs and LTE UEs are in a wireless communications system (e.g., via a default LTE channel occupancy, a default NR channel occupancy, a default quantity of resources allocated for NR UEs and LTE UEs, a default resource partition such as a slot, an index to a particular partition structure, and any other penetration rates). That is, the first UE (e.g., an NR UE) may be aware of multiple LTE UEs in the system. Based on the configuration for the coexistence of resources, the first UE may determine an initial resource pool partition, which may indicate how many resources in a resource pool the first UE and the second UE may each occupy for their respective transmissions.

In some cases, the base station may configure the first UE with, or the first UE may be preconfigured with, a measurement period T₀ (e.g., an initial LTE channel occupancy measurement period). During the measurement period T₀, the first UE may perform a measurement of a sidelink control channel (e.g., an LTE sidelink control channel, a control channel associated with the second RAT) in response to receiving the configuration for the coexistence of resources at 305. Put another way, after the measurement period T₀, at 310, the initial penetration rate estimate indicated by the base station or preconfigured for the first UE may be non-optimal (e.g., the initial penetration rate estimate be an initial value that has a small impact on LTE), and the first UE may measure an updated penetration rate estimate to determine a more accurate resource pool partition frame structure.

Based on measuring the sidelink control channel, the first UE may determine an updated penetration rate estimate (e.g., R₁) which the first UE may use to determine an initial resource pool partition frame structure (e.g., a channel occupancy ratio). For example, the first UE may determine a partition of resources of a resource pool based on measuring the sidelink control channel, where a first group of the partition of resources may be associated with the second RAT (e.g., LTE) and a second group of the partition of resources may be associated with the first RAT (e.g., NR). As such, the first UE may use the second group to perform NR communications with the base station, and the second UE may use the first group to perform LTE communications with the base station.

In some examples, the base station may configure the first UE with, or the first UE may be preconfigured with, one or more update periods Tₚₑᵣ after the measurement period T₀. During each update period Tₚₑᵣ, the first UE may continue monitoring the sidelink control channel and make subsequent updates to the resource pool partition frame structure if the first UE determines a change in the corresponding penetration rate estimate during that update period Tₚₑᵣ. For example, after a first update period Tₚₑᵣ, at 315, the first UE may determine that the penetration rate estimate has changed (e.g., more or fewer NR UEs are now in the system, the percentage of NR UEs in the system changed from 50% to 40%), and as such, the first UE may determine a second updated resource pool partition frame structure (e.g., R₂). After a second update period Tₚₑᵣ, at 320, the first UE may determine little to no change to the penetration rate estimate (e.g., the quantity of NR UEs in the system remained the same, the percentage of NR UEs in the system changed from 50% to 49%), and as such, the first UE may refrain from updating the resource pool partition frame structure. That is, the resource pool partition frame structure may be the same at 315 and at 320.

During the measurement period T₀ and each of the update periods Tₚₑᵣ, the first UE may decode one or more sidelink scheduling assignments (e.g., scheduling assignments associated with the second RAT, sidelink LTE scheduling assignments) to determine an updated partition of the resources. Additionally or alternatively, the first UE may decode the one or more sidelink scheduling assignments to determine a first set of resources used for a current reservation (e.g., a first transmission), a second set of resources to be used for a future reservation (e.g., a retransmission, semi-persistent scheduling (SPS) resource signaling), a priority of the transmissions, a reference signal received power (RSRP) measured over the sidelink control channel, or any combination thereof. The first UE may determine an updated resource pool partition frame structure based on the received reservation information in the one or more decoded sidelink scheduling assignments, which may include channel occupancy information associated with the current reservation, both the current reservation and the future reservation, or one or more signaled future transmission occasions weighed by a factor of α<1, where a may represent a likelihood that a scheduled transmission may actually be transmitted in the future (e.g., α=0.5, which may indicate a 50% chance that a scheduled transmission may actually be transmitted).

In some cases, the first UE may filter the one or more sidelink scheduling assignments based on the received RSRP associated with the sidelink control channel, priority of traffic for which the resources are reserved (e.g., LTE, NR), or other channel characteristics. The first UE may use the filtered sidelink scheduling assignments to determine the updated resource pool partition frame structure. Based on the system (e.g., how many NR UEs and LTE UEs are in the system, what information is being communicated, a priority of different transmissions, and other factors), the first UE may use a combination of the criteria described herein to determine the updated resource pool partition frame structure. For example, the first UE may use the reservation information from the decoded sidelink scheduling assignments (e.g., the current and future reservations, the priority of the transmissions, the RSRP of the sidelink control channel), the filtered sidelink scheduling assignments, or any combination thereof to determine the updated resource pool partition frame structure. In addition, the first UE may determine the criteria based on a configuration transmitted by the base station (e.g., or a configuration preconfigured at the first UE), or based on an NR traffic pattern or any other transmission statistics (e.g., error rate, CBR, and other statistics).

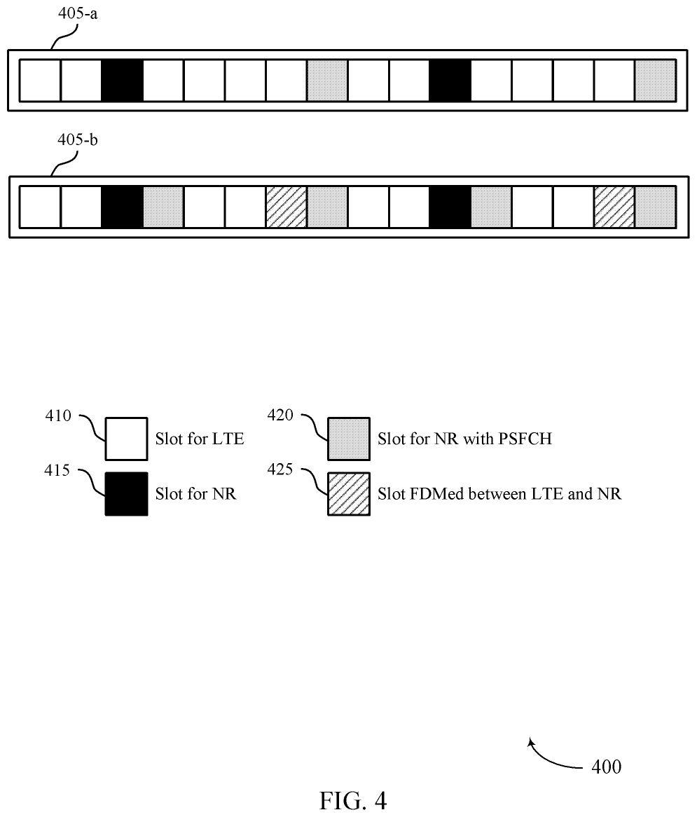

FIG. 4 illustrates an example of a set of resource pool partition frame structures 400 that supports LTE and NR sidelink co-channel coexistence in accordance with aspects of the present disclosure. In some examples, the set of resource pool partition frame structures 400 may implement aspects of the wireless communications systems 100 and 200 or may be implemented by aspects of the wireless communications systems 100 and 200. For example, a first UE (e.g., a UE that operates in accordance with a first RAT) may decode a sidelink control channel corresponding to a second RAT (e.g., an LTE sidelink control channel) to determine a resource pool partition frame structure 405-a or a resource pool partition frame structure 405-b.

In some examples, the first UE may be preconfigured with the set of resource pool partition frame structures 400, or the first UE may receive control signaling from a base station indicating a configuration for the set of resource pool partition frame structures 400. Each resource pool partition frame structure 405 may correspond to a particular NR penetration rate (e.g., NR channel occupancy) or to a particular range of NR penetration rates. For example, the resource pool partition frame structure 405-a may correspond to a relatively low NR penetration rate (e.g., a relatively low NR channel occupancy), and the resource pool partition frame structure 405-b may correspond to a relatively high NR penetration rate (e.g., a relatively high NR channel occupancy). Put another way, the resource pool partition frame structure 405-a may have a smaller quantity of resources dedicated to NR communications than the resource pool partition frame structure 405-b.

Each resource pool partition frame structure 405 may include different resources dedicated for use by the first UE using the first RAT (e.g., NR) and the second UE using the second RAT (e.g., LTE). For example, the resource pool partition frame structures 405 may include LTE slots 410 for use by the second UE for LTE communications, NR slots 415 for use by the first UE for NR communications (e.g., NR physical sidelink shared channel (PSSCH) and physical sidelink control channel (PSCCH) communications), slots 420 for use by the first UE for NR communications (e.g., NR PSSCH and PSCCH) communications), for PSFCH communications, or both, and FDMed slots 425 for use by the first UE and the second UE for LTE and NR communications, respectively.

In some examples, the resource pool partition frame structure 405-a may include twelve LTE slots 410, two NR slots 415, two slots 420, and no FDMed slots 425. As such, the resource pool partition frame structure 405-a may have a relatively low NR penetration rate (e.g., 25%, 4/16 slots) and a relatively high LTE penetration rate (e.g., 75%, 12/16 slots). Given these penetration rates (e.g., channel occupancies), the first UE may determine the resource pool partition frame structure 405-a for a system that includes more LTE UEs than NR UEs, higher LTE traffic than NR traffic, or both. In another example, the resource pool partition frame structure 405-b may include eight LTE slots 410, two NR slots 415, four slots 420, and two FDMed slots 425. As such, the resource pool partition frame structure 405-b may have a relatively high NR penetration rate (e.g., 44%, 7/16 slots including the FDMed slots 420). Given the 44% NR penetration rate, the first UE may determine the resource pool partition frame structure 405-b for a system that has a similar quantity of NR UEs to LTE UEs, relatively high NR traffic, or both.

In some cases, the first UE may determine an NR penetration rate for each resource pool partition frame structure 405 directly from an LTE channel occupancy (e.g., which may be preconfigured or configured for the first UE) using instantaneous measurements or time-average measurements. For example, the first UE may calculate the NR penetration rate R(t) by taking instantaneous measurements using Equation 1:

$$R ( t ) = 1 - {( LTE Chan Occupancy )}_{t - {T}_{0} \to t} / {( Total Available Resources )}_{t - {T}_{0} \to t} \qquad ( 1 )$$

where t may represent a time at which the first UE is measuring the NR penetration rate and T₀ may represent a measurement period. Additionally or alternatively, the first UE may calculate the NR penetration rate R(t) for each resource pool partition frame structure 405 by averaging multiple measurement instances using Equation 2:

$$R ( t ) = 1 - ( \frac{1}{{T}_{1}} ) {\sum }_{s = t - {T}_{1}}^{t} {( LTE Chan Occupancy )}_{t - {T}_{1} - {T}_{0} \to t - {T}_{1}} / {( Total Available Resources )}_{t - {T}_{1} - {T}_{0} \to t - {T}_{1}} \qquad ( 2 )$$

where t may represent a time at which the first UE is measuring the NR penetration rate and T₀ and T₁ may represent different measurement periods. For example, the first UE may measure the NR penetration rate in a first frame (e.g., Frame 1) between 0 seconds and 0.15 seconds (e.g., R(t)=[0→0.15]) and a second frame (e.g., Frame 2) between 0.15 seconds and 0.25 seconds (e.g., R(t)=(0.15→0.25]), and so on. In both Equation 1 and Equation 2, the first UE may generally divide the LTE channel occupancy (e.g., LTE Chan Occupancy) by the quantity of total available resources in a resource pool (e.g., 16 resources in each of the resource pool partition frame structures 405) to calculate an NR penetration rate. As such, the first UE may determine the resource pool partition frame structures 405 based on a computed NR penetration rate a preconfigured or configured LTE penetration rate. In some cases, the first UE may apply the resource pool partition frame structure 405-a or the resource pool partition frame structure 405-b after a configured time T₂ from the time of the determination, where T₂ may be zero (e.g., the first UE may apply a resource pool partition frame structure 405 immediately after it is determined).

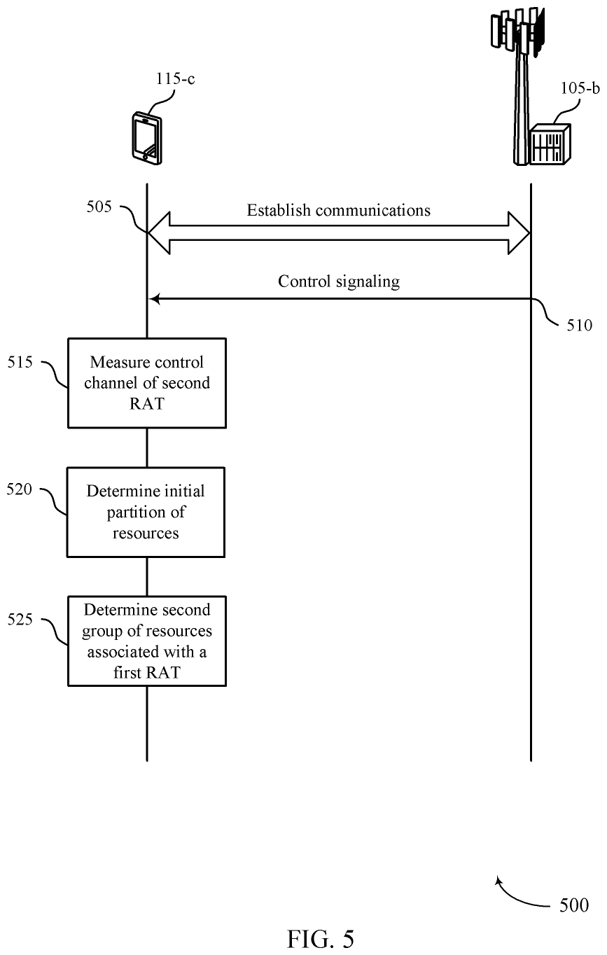

FIG. 5 illustrates an example of a process flow 500 that supports LTE and NR sidelink co-channel coexistence in accordance with aspects of the present disclosure. The process flow 500 may implement aspects of wireless communications systems 100 and 200, or may be implemented by aspects of the wireless communications system 100 and 200. For example, the process flow 500 may illustrate operations between a UE 115-c and a base station 105-b, which may be examples of corresponding devices described herein. In the following description of the process flow 500, the operations between the UE 115-c and the base station 105-b may be transmitted in a different order than the example order shown, or the operations performed by the UE 115-c and the base station 105-b may be performed in different orders or at different times. Some operations may also be omitted from the process flow 500, and other operations may be added to the process flow 500.

At 505, the base station 105-b may establish communications with the UE 115-c using a first RAT (e.g., NR). At 510, the UE 115-c may receive, from the base station 105-b, control signaling including an indication of a configuration for a coexistence of resources used for the first RAT and a second RAT (e.g., LTE), where the UE 115-c operates in accordance with the first RAT. In some examples, the configuration for the coexistence of resources may indicate an initial estimate of how many NR UEs (e.g., UEs 115 operating in accordance with NR) and LTE UEs (e.g., UEs 115 operating in accordance with LTE) may use resources in a same channel or band.

At 515, the UE 115-c may perform, during a measurement period (e.g., To), a measurement of a control channel of the second RAT (e.g., an LTE sidelink control channel) in response to receiving the control signaling. In some examples, the UE 115-c may measure one or more sidelink scheduling assignments associated with the control channel to determine different channel parameters (e.g., a priority of reserved transmissions, an RSRP of the control channel, and the like) during the measurement period.

At 520, the UE 115-c may determine an initial partition of the resources based on the configuration and the measurement, where a first group of the initial partition of the resources may be associated with the second RAT. The initial partition of the resources (e.g., a resource pool partition frame structure) may indicate how many resources in a resource pool may be used by the first UE for NR communications or the second UE for LTE communications. In some cases, the UE 115-c may determine the initial partition of the resources based on an NR penetration rate (e.g., an NR channel occupancy), which the UE 115-c may calculate based on an LTE penetration rate (e.g., an LTE channel occupancy).

At 525, the UE 115-c may determine a second group of the initial partition of the resources that is associated with the first RAT. For example, the UE 115-c may determine the second group of the initial partition of the resources based on the NR penetration rate (e.g., how many NR UEs are in the system). In some examples, the UE 115-c may determine an updated partition of the resources that is different from the initial partition of the resources based on changes to an NR penetration rate, an LTE penetration rate, or both, and as such, the first UE 115-c may update the first and second groups of the initial partition of the resources.

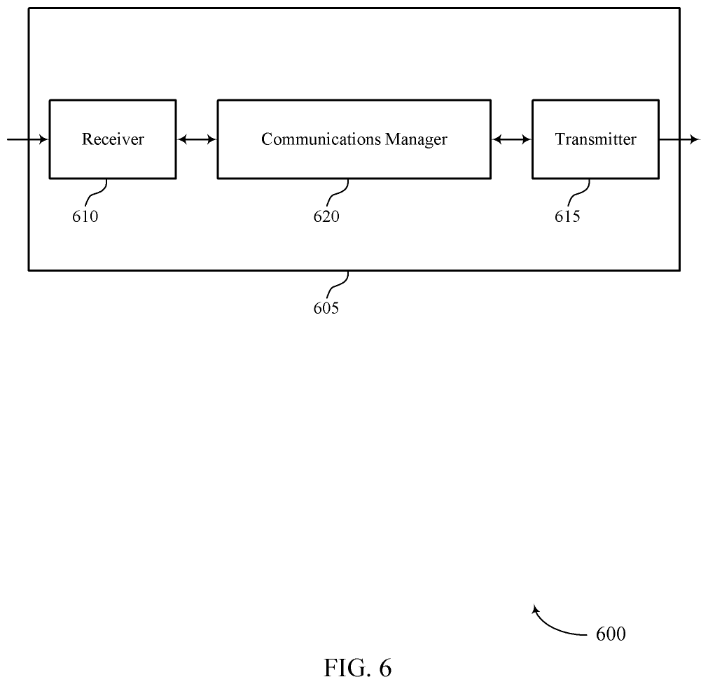

FIG. 6 shows a block diagram 600 of a device 605 that supports LTE and NR sidelink co-channel coexistence in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to LTE and NR sidelink co-channel coexistence). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to LTE and NR sidelink co-channel coexistence). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of LTE and NR sidelink co-channel coexistence as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a base station, control signaling including an indication of a configuration for a coexistence of resources used for a first RAT and a second RAT, where the UE operates in accordance with the first RAT. The communications manager 620 may be configured as or otherwise support a means for performing, during a measurement period, a measurement of a control channel of the second RAT in response to the receiving. The communications manager 620 may be configured as or otherwise support a means for determining an initial partition of the resources based on the configuration and the measurement, where a first group of the initial partition of the resources is associated with the second RAT.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for LTE and NR sidelink co-channel coexistence, which may increase resource utilization efficiency, reduce collisions, and improve overall UE performance.

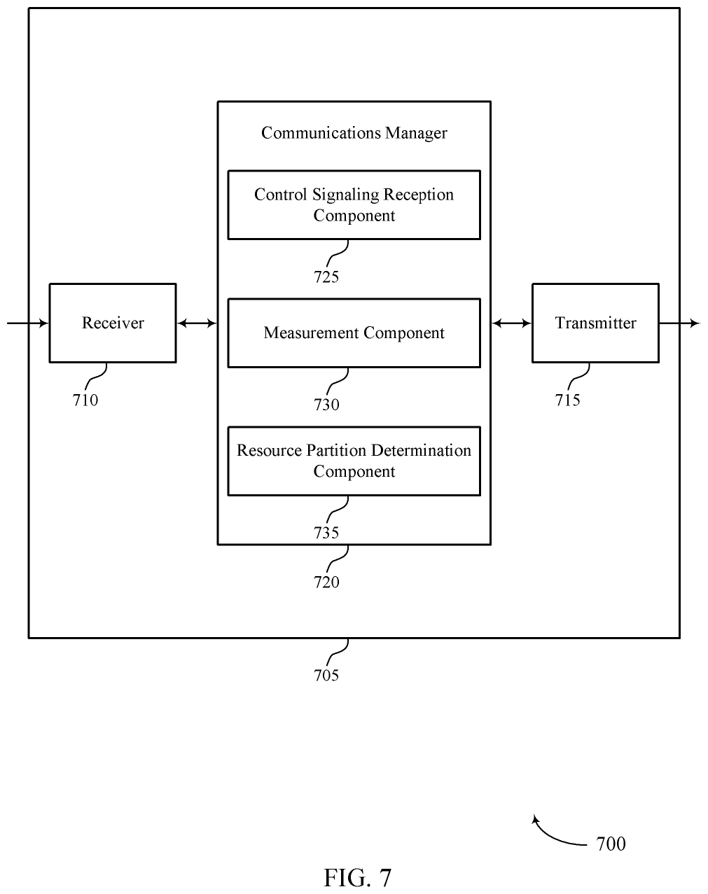

FIG. 7 shows a block diagram 700 of a device 705 that supports LTE and NR sidelink co-channel coexistence in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to LTE and NR sidelink co-channel coexistence). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to LTE and NR sidelink co-channel coexistence). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of LTE and NR sidelink co-channel coexistence as described herein. For example, the communications manager 720 may include a control signaling reception component 725, a measurement component 730, a resource partition determination component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The control signaling reception component 725 may be configured as or otherwise support a means for receiving, from a base station, control signaling including an indication of a configuration for a coexistence of resources used for a first RAT and a second RAT, where the UE operates in accordance with the first RAT. The measurement component 730 may be configured as or otherwise support a means for performing, during a measurement period, a measurement of a control channel of the second RAT in response to the receiving. The resource partition determination component 735 may be configured as or otherwise support a means for determining an initial partition of the resources based on the configuration and the measurement, where a first group of the initial partition of the resources is associated with the second RAT.

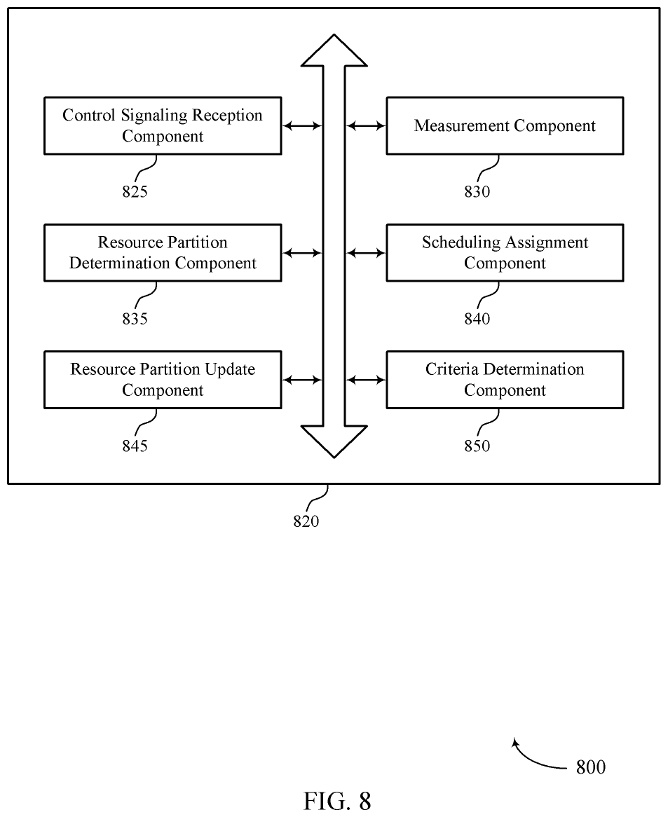

FIG. 8 shows a block diagram 800 of a communications manager 820 that supports LTE and NR sidelink co-channel coexistence in accordance with aspects of the present disclosure. The communications manager 820 may be an example of aspects of a communications manager 620, a communications manager 720, or both, as described herein. The communications manager 820, or various components thereof, may be an example of means for performing various aspects of LTE and NR sidelink co-channel coexistence as described herein. For example, the communications manager 820 may include a control signaling reception component 825, a measurement component 830, a resource partition determination component 835, a scheduling assignment component 840, a resource partition update component 845, a criteria determination component 850, or any combination thereof. Each of these components may communicate, directly or indirectly, with one another (e.g., via one or more buses).

The communications manager 820 may support wireless communication at a UE in accordance with examples as disclosed herein. The control signaling reception component 825 may be configured as or otherwise support a means for receiving, from a base station, control signaling including an indication of a configuration for a coexistence of resources used for a first RAT and a second RAT, where the UE operates in accordance with the first RAT. The measurement component 830 may be configured as or otherwise support a means for performing, during a measurement period, a measurement of a control channel of the second RAT in response to the receiving. The resource partition determination component 835 may be configured as or otherwise support a means for determining an initial partition of the resources based on the configuration and the measurement, where a first group of the initial partition of the resources is associated with the second RAT.

In some examples, the scheduling assignment component 840 may be configured as or otherwise support a means for decoding a set of multiple sidelink scheduling assignments associated with the second RAT during the measurement period. In some examples, the resource partition update component 845 may be configured as or otherwise support a means for determining an updated partition of the resources based on the decoding.

In some examples, the scheduling assignment component 840 may be configured as or otherwise support a means for determining a first quantity of resources reserved for a first transmission of a set of multiple transmissions, a second quantity of resources reserved for a future transmission of the set of multiple transmissions, a priority of the set of multiple transmissions, an RSRP associated with the control channel of the second RAT, or any combination thereof. In some examples, the resource partition update component 845 may be configured as or otherwise support a means for determining the updated partition of the resources based on the determining.

In some examples, the future transmission includes a retransmission of the first transmission of the set of multiple transmissions or SPS resource signaling.

In some examples, the scheduling assignment component 840 may be configured as or otherwise support a means for filtering the set of multiple sidelink scheduling assignments based on the RSRP associated with the control channel of the second RAT, the priority of the set of multiple transmissions, or any combination thereof.

In some examples, to support receiving the control signaling, the control signaling reception component 825 may be configured as or otherwise support a means for receiving the control signaling including an indication of the measurement period, a set of multiple update periods after the measurement period, or a combination thereof.

In some examples, the resource partition update component 845 may be configured as or otherwise support a means for determining an updated partition of the resources according to a first update period of the set of multiple update periods after the measurement period, where the updated partition of the resources is different from the initial partition of the resources.

In some examples, to support receiving the control signaling, the control signaling reception component 825 may be configured as or otherwise support a means for receiving the control signaling indicating at least one criterion for determining the initial partition of the resources by the UE.

In some examples, the criteria determination component 850 may be configured as or otherwise support a means for determining at least one criterion for determining the initial partition of the resources based on a signaling traffic pattern, a transmission statistic, or any combination thereof.

In some examples, the resource partition determination component 835 may be configured as or otherwise support a means for determining a second group of the initial partition of the resources that is associated with the first RAT based on receiving the control signaling.

In some examples, to support receiving the control signaling, the control signaling reception component 825 may be configured as or otherwise support a means for receiving the control signaling including an indication of the second group of the initial partition of the resources that is associated with the first RAT. In some examples, the control channel of the second RAT comprises a sidelink control channel. In some examples, the first RAT includes 5G NR and the second RAT includes LTE.

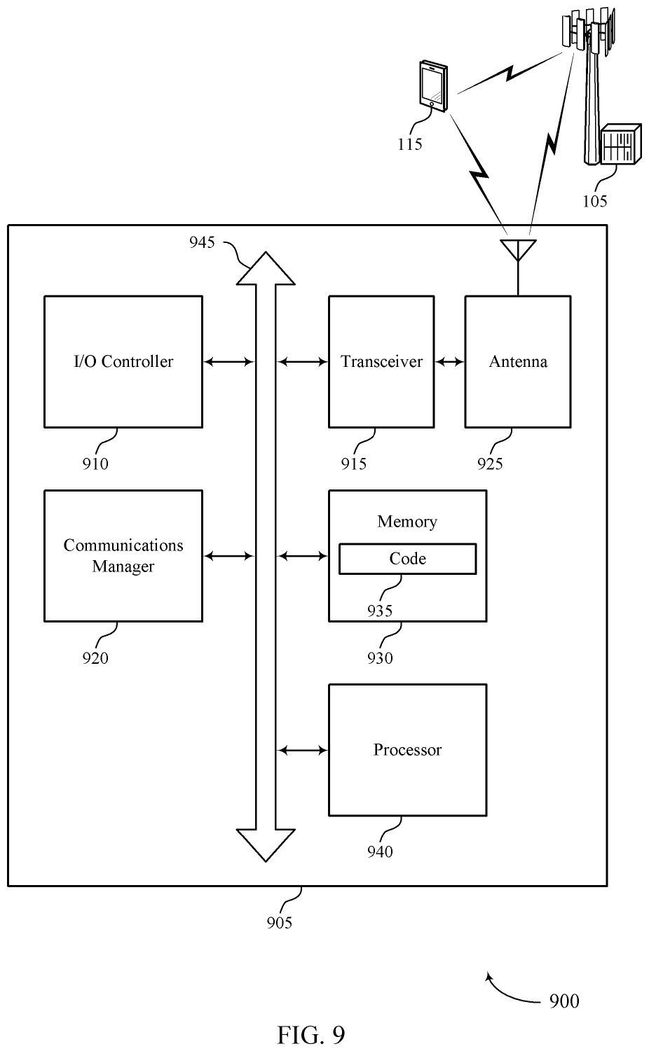

FIG. 9 shows a diagram of a system 900 including a device 905 that supports LTE and NR sidelink co-channel coexistence in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting LTE and NR sidelink co-channel coexistence). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a base station, control signaling including an indication of a configuration for a coexistence of resources used for a first RAT and a second RAT, where the UE operates in accordance with the first RAT. The communications manager 920 may be configured as or otherwise support a means for performing, during a measurement period, a measurement of a control channel of the second RAT in response to the receiving. The communications manager 920 may be configured as or otherwise support a means for determining an initial partition of the resources based on the configuration and the measurement, where a first group of the initial partition of the resources is associated with the second RAT.

By including or configuring the communications manager 920 in accordance with examples as described herein, the device 905 may support techniques for LTE and NR sidelink co-channel coexistence, which may increase resource utilization efficiency, reduce collisions, and improve overall UE performance and communications between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of LTE and NR sidelink co-channel coexistence as described herein, or the processor 940 and the memory 930 may be otherwise configured to perform or support such operations.

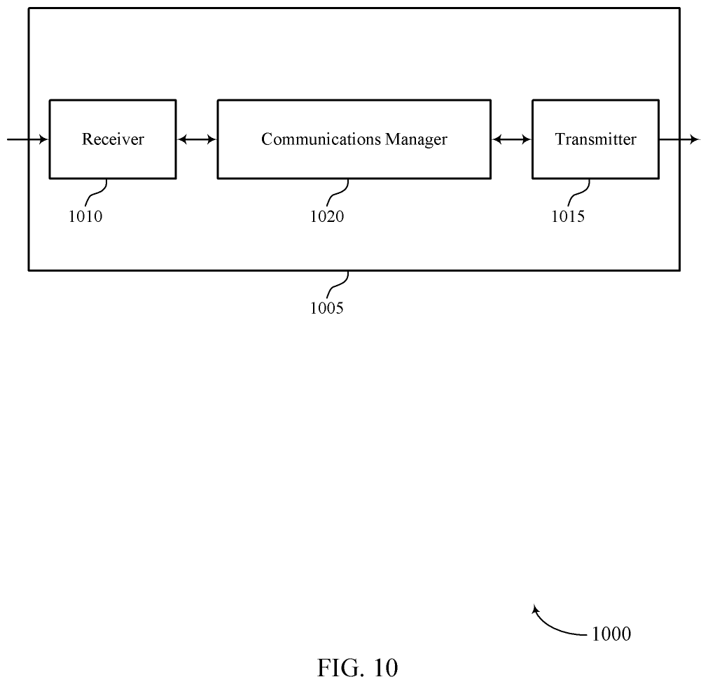

FIG. 10 shows a block diagram 1000 of a device 1005 that supports LTE and NR sidelink co-channel coexistence in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to LTE and NR sidelink co-channel coexistence). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to LTE and NR sidelink co-channel coexistence). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of LTE and NR sidelink co-channel coexistence as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. For example, the communications manager 1020 may be configured as or otherwise support a means for establishing communications with a UE using a first RAT. The communications manager 1020 may be configured as or otherwise support a means for transmitting, to the UE, control signaling including an indication of a configuration for a coexistence of resources used for the first RAT and a second RAT, where the UE operates in accordance with the first RAT.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for LTE and NR sidelink co-channel coexistence, which may increase resource utilization efficiency, reduce collisions, and improve overall UE performance.

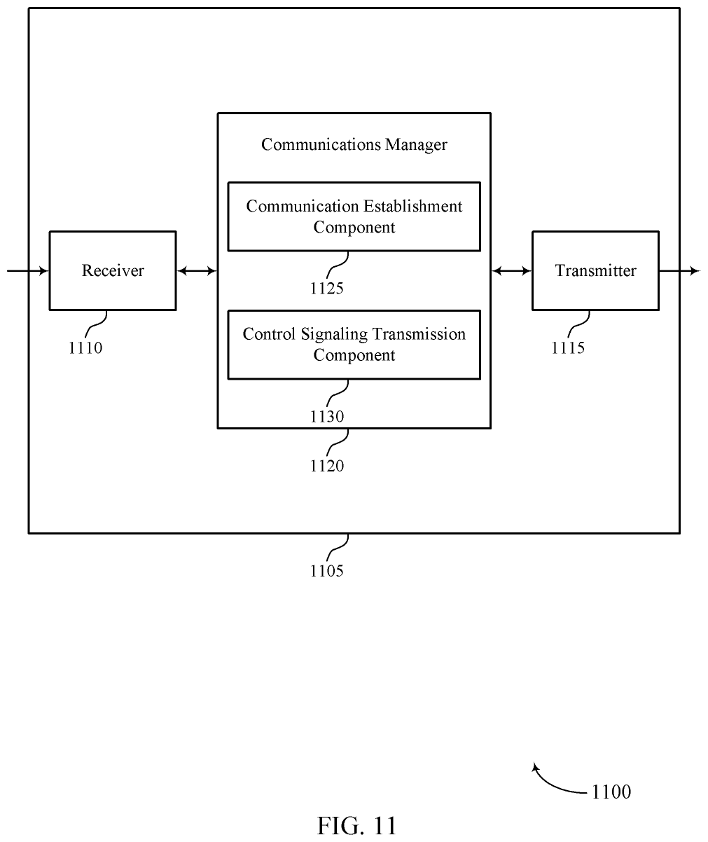

FIG. 11 shows a block diagram 1100 of a device 1105 that supports LTE and NR sidelink co-channel coexistence in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to LTE and NR sidelink co-channel coexistence). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to LTE and NR sidelink co-channel coexistence). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of LTE and NR sidelink co-channel coexistence as described herein. For example, the communications manager 1120 may include a communication establishment component 1125 a control signaling transmission component 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. The communication establishment component 1125 may be configured as or otherwise support a means for establishing communications with a UE using a first RAT. The control signaling transmission component 1130 may be configured as or otherwise support a means for transmitting, to the UE, control signaling including an indication of a configuration for a coexistence of resources used for the first RAT and a second RAT, where the UE operates in accordance with the first RAT.

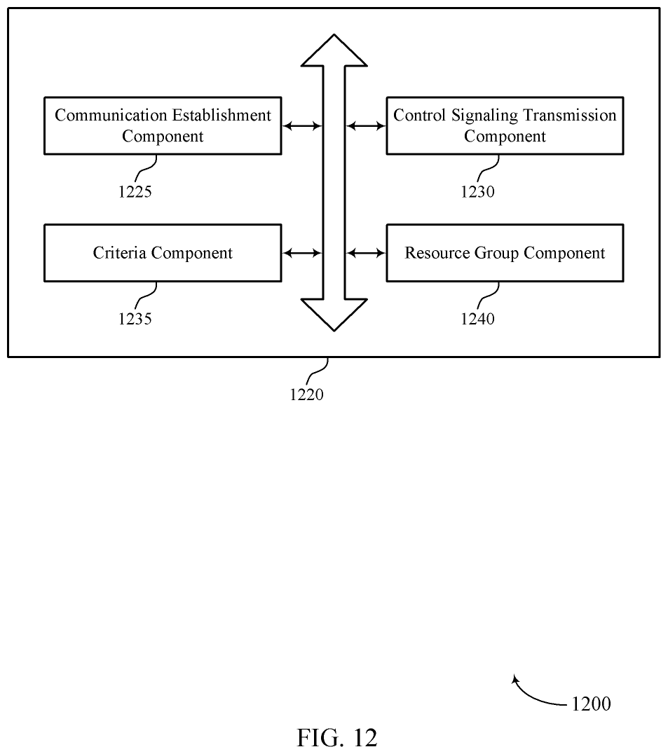

FIG. 12 shows a block diagram 1200 of a communications manager 1220 that supports LTE and NR sidelink co-channel coexistence in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of LTE and NR sidelink co-channel coexistence as described herein. For example, the communications manager 1220 may include a communication establishment component 1225, a control signaling transmission component 1230, a criteria component 1235, a resource group component 1240, or any combination thereof. Each of these components may communicate, directly or indirectly, with one another (e.g., via one or more buses).

The communications manager 1220 may support wireless communication at a base station in accordance with examples as disclosed herein. The communication establishment component 1225 may be configured as or otherwise support a means for establishing communications with a UE using a first RAT. The control signaling transmission component 1230 may be configured as or otherwise support a means for transmitting, to the UE, control signaling including an indication of a configuration for a coexistence of resources used for the first RAT and a second RAT, where the UE operates in accordance with the first RAT.

In some examples, to support transmitting the control signaling, the control signaling transmission component 1230 may be configured as or otherwise support a means for transmitting the control signaling including an indication of a measurement period, a set of multiple update periods after the measurement period, or a combination thereof.

In some examples, to support transmitting the control signaling, the criteria component 1235 may be configured as or otherwise support a means for transmitting the control signaling indicating at least one criterion for determining an initial partition of the resources by the UE.

In some examples, to support transmitting the control signaling, the resource group component 1240 may be configured as or otherwise support a means for transmitting the control signaling including an indication of a first group of an initial partition of the resources associated with the second RAT and a second group of the initial partition of the resources associated with the first RAT. In some examples, the control channel of the second RAT comprises a sidelink control channel. In some examples, the first RAT includes 5G NR and the second RAT includes LTE.

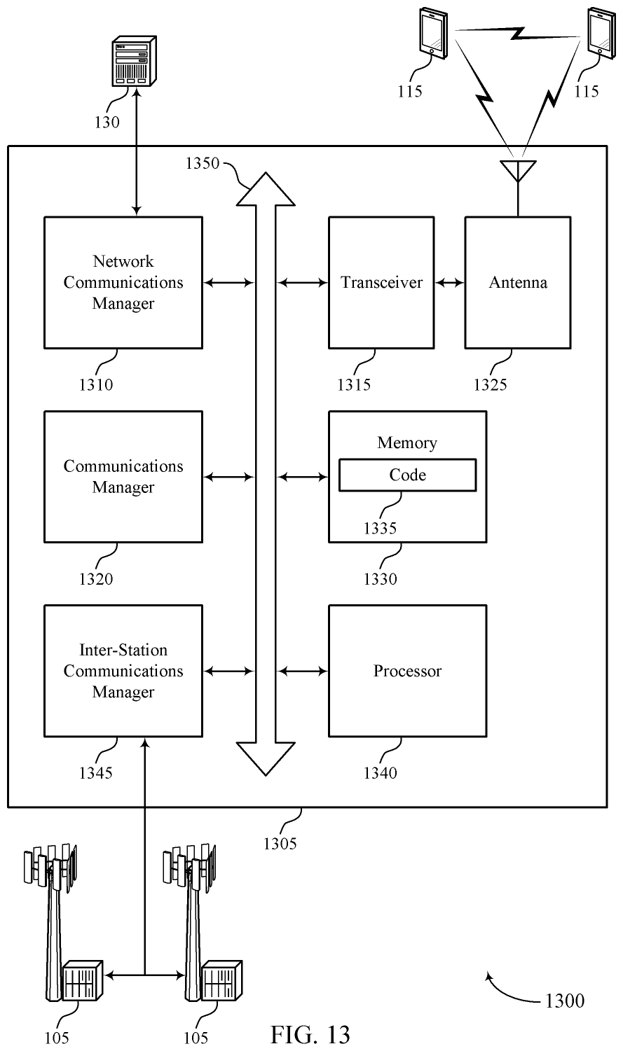

FIG. 13 shows a diagram of a system 1300 including a device 1305 that supports LTE and NR sidelink co-channel coexistence in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting LTE and NR sidelink co-channel coexistence). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a base station in accordance with examples as disclosed herein. For example, the communications manager 1320 may be configured as or otherwise support a means for establishing communications with a UE using a first RAT. The communications manager 1320 may be configured as or otherwise support a means for transmitting, to the UE, control signaling including an indication of a configuration for a coexistence of resources used for the first RAT and a second RAT, where the UE operates in accordance with the first RAT.

By including or configuring the communications manager 1320 in accordance with examples as described herein, the device 1305 may support techniques for LTE and NR sidelink co-channel coexistence, which may increase resource utilization efficiency, reduce collisions, and improve overall UE performance and communications between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of LTE and NR sidelink co-channel coexistence as described herein, or the processor 1340 and the memory 1330 may be otherwise configured to perform or support such operations.

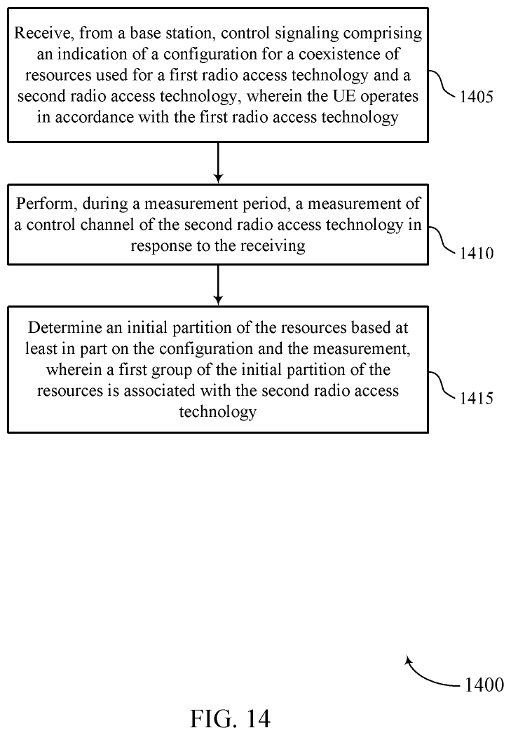

FIG. 14 shows a flowchart illustrating a method 1400 that supports LTE and NR sidelink co-channel coexistence in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling including an indication of a configuration for a coexistence of resources used for a first RAT and a second RAT, where the UE operates in accordance with the first RAT. The operations of 1405 may be performed in accordance with examples as disclosed herein. In some examples, aspects of the operations of 1405 may be performed by a control signaling reception component 825 as described with reference to FIG. 8.

At 1410, the method may include performing, during a measurement period, a measurement of a control channel of the second RAT in response to the receiving. The operations of 1410 may be performed in accordance with examples as disclosed herein. In some examples, aspects of the operations of 1410 may be performed by a measurement component 830 as described with reference to FIG. 8.

At 1415, the method may include determining an initial partition of the resources based on the configuration and the measurement, where a first group of the initial partition of the resources is associated with the second RAT. The operations of 1415 may be performed in accordance with examples as disclosed herein. In some examples, aspects of the operations of 1415 may be performed by a resource partition determination component 835 as described with reference to FIG. 8.

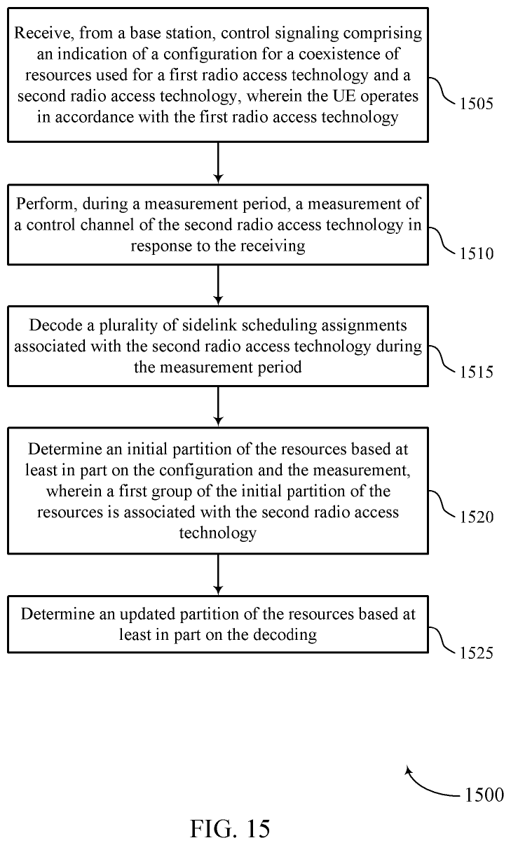

FIG. 15 shows a flowchart illustrating a method 1500 that supports LTE and NR sidelink co-channel coexistence in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, control signaling including an indication of a configuration for a coexistence of resources used for a first RAT and a second RAT, where the UE operates in accordance with the first RAT. The operations of 1505 may be performed in accordance with examples as disclosed herein. In some examples, aspects of the operations of 1505 may be performed by a control signaling reception component 825 as described with reference to FIG. 8.

At 1510, the method may include performing, during a measurement period, a measurement of a control channel of the second RAT in response to the receiving. The operations of 1510 may be performed in accordance with examples as disclosed herein. In some examples, aspects of the operations of 1510 may be performed by a measurement component 830 as described with reference to FIG. 8.

At 1515, the method may include decoding a set of multiple sidelink scheduling assignments associated with the second RAT during the measurement period. The operations of 1515 may be performed in accordance with examples as disclosed herein. In some examples, aspects of the operations of 1515 may be performed by a scheduling assignment component 840 as described with reference to FIG. 8.

At 1520, the method may include determining an initial partition of the resources based on the configuration and the measurement, where a first group of the initial partition of the resources is associated with the second RAT. The operations of 1520 may be performed in accordance with examples as disclosed herein. In some examples, aspects of the operations of 1520 may be performed by a resource partition determination component 835 as described with reference to FIG. 8.

At 1525, the method may include determining an updated partition of the resources based on the decoding. The operations of 1525 may be performed in accordance with examples as disclosed herein. In some examples, aspects of the operations of 1525 may be performed by a resource partition update component 845 as described with reference to FIG. 8.

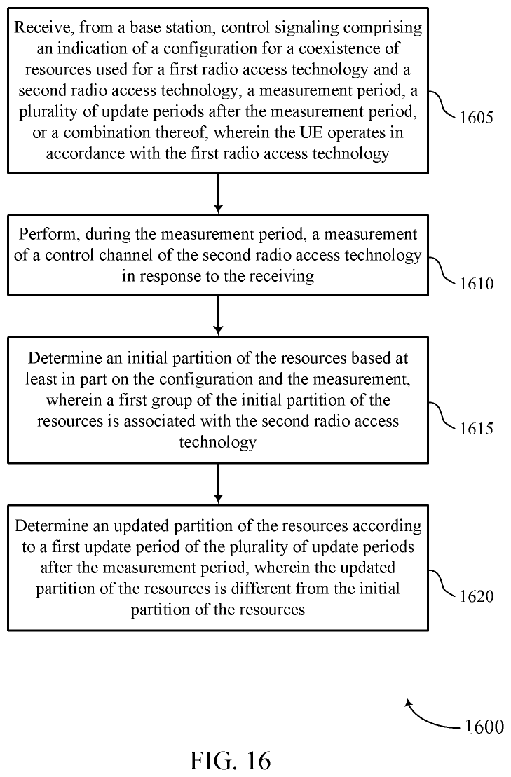

FIG. 16 shows a flowchart illustrating a method 1600 that supports LTE and NR sidelink co-channel coexistence in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, control signaling including an indication of a configuration for a coexistence of resources used for a first RAT and a second RAT, a measurement period, a plurality of update periods after the measurement period, or a combination thereof, where the UE operates in accordance with the first RAT. The operations of 1605 may be performed in accordance with examples as disclosed herein. In some examples, aspects of the operations of 1605 may be performed by a control signaling reception component 825 as described with reference to FIG. 8.

At 1610, the method may include performing, during a measurement period, a measurement of a control channel of the second RAT in response to the receiving. The operations of 1610 may be performed in accordance with examples as disclosed herein. In some examples, aspects of the operations of 1610 may be performed by a measurement component 830 as described with reference to FIG. 8.

At 1615, the method may include determining an initial partition of the resources based on the configuration and the measurement, where a first group of the initial partition of the resources is associated with the second RAT. The operations of 1615 may be performed in accordance with examples as disclosed herein. In some examples, aspects of the operations of 1615 may be performed by a resource partition determination component 835 as described with reference to FIG. 8.

At 1620, the method may include determining an updated partition of the resources according to a first update period of the set of multiple update periods after the measurement period, where the updated partition of the resources is different from the initial partition of the resources. The operations of 1620 may be performed in accordance with examples as disclosed herein. In some examples, aspects of the operations of 1620 may be performed by a resource partition update component 845 as described with reference to FIG. 8.

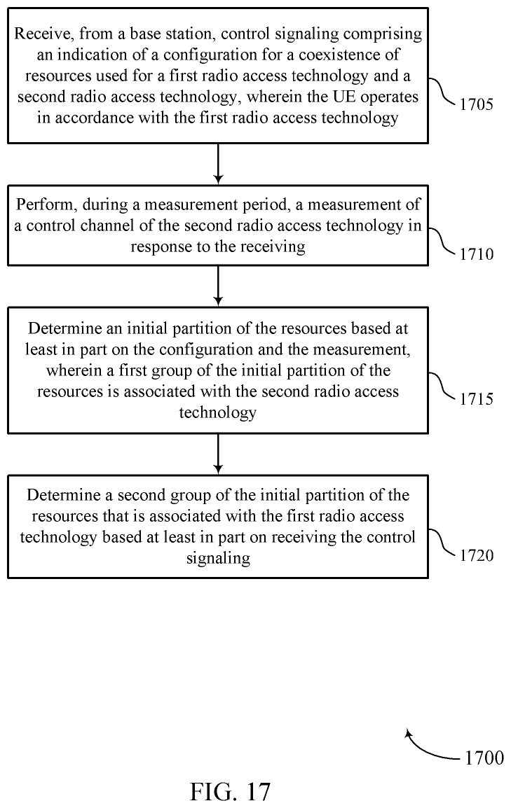

FIG. 17 shows a flowchart illustrating a method 1700 that supports LTE and NR sidelink co-channel coexistence in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, control signaling including an indication of a configuration for a coexistence of resources used for a first RAT and a second RAT, where the UE operates in accordance with the first RAT. The operations of 1705 may be performed in accordance with examples as disclosed herein. In some examples, aspects of the operations of 1705 may be performed by a control signaling reception component 825 as described with reference to FIG. 8.

At 1710, the method may include performing, during a measurement period, a measurement of a control channel of the second RAT in response to the receiving. The operations of 1710 may be performed in accordance with examples as disclosed herein. In some examples, aspects of the operations of 1710 may be performed by a measurement component 830 as described with reference to FIG. 8.

At 1715, the method may include determining an initial partition of the resources based on the configuration and the measurement, where a first group of the initial partition of the resources is associated with the second RAT. The operations of 1715 may be performed in accordance with examples as disclosed herein. In some examples, aspects of the operations of 1715 may be performed by a resource partition determination component 835 as described with reference to FIG. 8.

At 1720, the method may include determining a second group of the initial partition of the resources that is associated with the first RAT based on receiving the control signaling. The operations of 1720 may be performed in accordance with examples as disclosed herein. In some examples, aspects of the operations of 1720 may be performed by a resource partition determination component 835 as described with reference to FIG. 8.

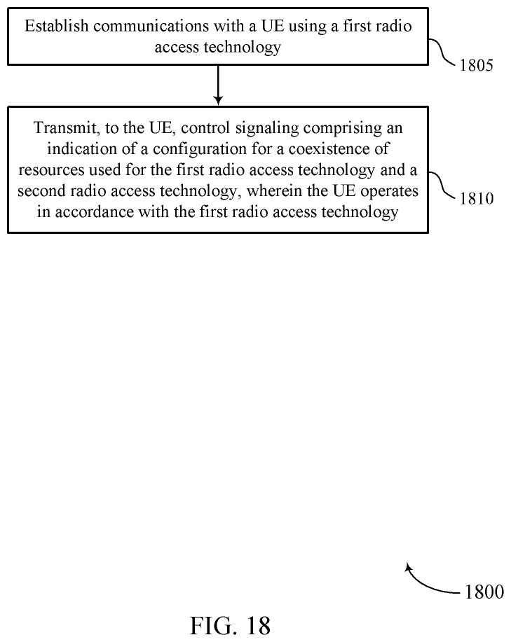

FIG. 18 shows a flowchart illustrating a method 1800 that supports LTE and NR sidelink co-channel coexistence in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include establishing communications with a UE using a first RAT. The operations of 1805 may be performed in accordance with examples as disclosed herein. In some examples, aspects of the operations of 1805 may be performed by a communication establishment component 1225 as described with reference to FIG. 12.

At 1810, the method may include transmitting, to the UE, control signaling including an indication of a configuration for a coexistence of resources used for the first RAT and a second RAT, where the UE operates in accordance with the first RAT. The operations of 1810 may be performed in accordance with examples as disclosed herein. In some examples, aspects of the operations of 1810 may be performed by a control signaling transmission component 1230 as described with reference to FIG. 12.

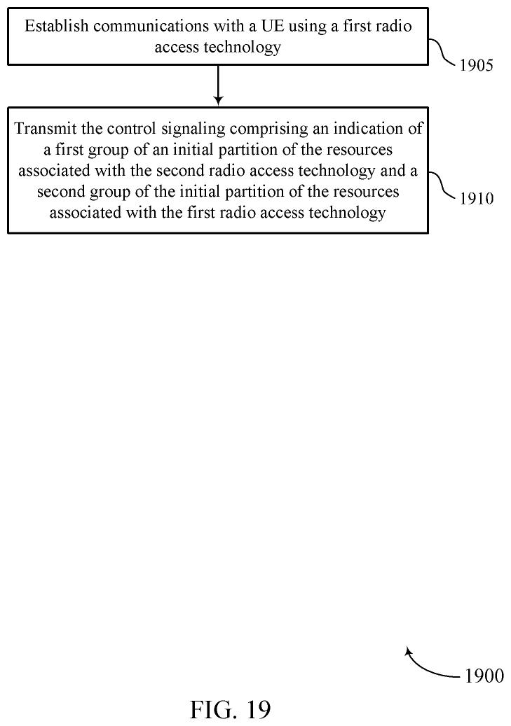

FIG. 19 shows a flowchart illustrating a method 1900 that supports LTE and NR sidelink co-channel coexistence in accordance with aspects of the present disclosure. The operations of the method 1900 may be implemented by a base station or its components as described herein. For example, the operations of the method 1900 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1905, the method may include establishing communications with a UE using a first RAT. The operations of 1905 may be performed in accordance with examples as disclosed herein. In some examples, aspects of the operations of 1905 may be performed by a communication establishment component 1225 as described with reference to FIG. 12.

At 1910, the method may include transmitting the control signaling including an indication of a first group of an initial partition of the resources associated with the second RAT and a second group of the initial partition of the resources associated with the first RAT. The operations of 1910 may be performed in accordance with examples as disclosed herein. In some examples, aspects of the operations of 1910 may be performed by a resource group component 1240 as described with reference to FIG. 12.

The following provides an overview of aspects of the present disclosure:

Aspect 1: A method for wireless communication at a UE, comprising: receiving, from a base station, control signaling comprising an indication of a configuration for a coexistence of resources used for a first RAT and a second RAT, wherein the UE operates in accordance with the first RAT; performing, during a measurement period, a measurement of a control channel of the second RAT in response to the receiving; and determining an initial partition of the resources based at least in part on the configuration and the measurement, wherein a first group of the initial partition of the resources is associated with the second RAT.

Aspect 2: The method of aspect 1, further comprising: decoding a plurality of sidelink scheduling assignments associated with the second RAT during the measurement period; and determining an updated partition of the resources based at least in part on the decoding.

Aspect 3: The method of aspect 2, further comprising: determining a first quantity of resources reserved for a first transmission of a plurality of transmissions, a second quantity of resources reserved for a future transmission of the plurality of transmissions, a priority of the plurality of transmissions, an RSRP associated with the control channel of the second RAT, or any combination thereof; and determining the updated partition of the resources based at least in part on the determining.

Aspect 4: The method of aspect 3, wherein the future transmission comprises a retransmission of the first transmission of the plurality of transmissions or SPS resource signaling.

Aspect 5: The method of any of aspects 3 through 4, further comprising: filtering the plurality of sidelink scheduling assignments based at least in part on the RSRP associated with the control channel of the second r RAT, the priority of the plurality of transmissions, or any combination thereof.

Aspect 6: The method of any of aspects 1 through 5, wherein receiving the control signaling comprises: receiving the control signaling comprising an indication of the measurement period, a plurality of update periods after the measurement period, or a combination thereof.

Aspect 7: The method of aspect 6, further comprising: determining an updated partition of the resources according to a first update period of the plurality of update periods after the measurement period, wherein the updated partition of the resources is different from the initial partition of the resources.

Aspect 8: The method of any of aspects 1 through 7, wherein receiving the control signaling comprises: receiving the control signaling indicating at least one criterion for determining the initial partition of the resources by the UE.

Aspect 9: The method of any of aspects 1 through 8, further comprising: determining at least one criterion for determining the initial partition of the resources based at least in part on a signaling traffic pattern, a transmission statistic, or any combination thereof.

Aspect 10: The method of any of aspects 1 through 9, further comprising: determining a second group of the initial partition of the resources that is associated with the first RAT based at least in part on receiving the control signaling.

Aspect 11: The method of any of aspects 1 through 10, wherein receiving the control signaling comprises: receiving the control signaling comprising an indication of the second group of the initial partition of the resources that is associated with the first RAT.

Aspect 12: The method of any of aspects 1 through 11, wherein the control channel of the second RAT comprises a sidelink control channel.

Aspect 13: The method of any of aspects 1 through 12, wherein the first RAT comprises 5G NR and the RAT technology comprises LTE.

Aspect 14: A method for wireless communication at a base station, comprising: establishing communications with a UE using a first RAT; and transmitting, to the UE, control signaling comprising an indication of a configuration for a coexistence of resources used for the first RAT and a second RAT, wherein the UE operates in accordance with the first RAT.

Aspect 15: The method of aspect 14, wherein transmitting the control signaling comprises: transmitting the control signaling comprising an indication of a measurement period, a plurality of update periods after the measurement period, or a combination thereof.

Aspect 16: The method of any of aspects 14 through 15, wherein transmitting the control signaling comprises: transmitting the control signaling indicating at least one criterion for determining an initial partition of the resources by the UE.

Aspect 17: The method of any of aspects 14 through 16, wherein transmitting the control signaling comprises: transmitting the control signaling comprising an indication of a first group of an initial partition of the resources associated with the second RAT and a second group of the initial partition of the resources associated with the first RAT.

Aspect 18: The method of any of aspects 14 through 17, wherein the first RAT comprises 5G NR and the second RAT comprises LTE.

Aspect 19: An apparatus for wireless communication at a UE, comprising a processor; memory coupled with the processor; and instructions stored in the memory and executable by the processor to cause the apparatus to perform a method of any of aspects 1 through 13.

Aspect 20: An apparatus for wireless communication at a UE, comprising at least one means for performing a method of any of aspects 1 through 13.

Aspect 21: A non-transitory computer-readable medium storing code for wireless communication at a UE, the code comprising instructions executable by a processor to perform a method of any of aspects 1 through 13.

Aspect 22: An apparatus for wireless communication at a base station, comprising a processor; memory coupled with the processor; and instructions stored in the memory and executable by the processor to cause the apparatus to perform a method of any of aspects 14 through 18.

Aspect 23: An apparatus for wireless communication at a base station, comprising at least one means for performing a method of any of aspects 14 through 18.

Aspect 24: A non-transitory computer-readable medium storing code for wireless communication at a base station, the code comprising instructions executable by a processor to perform a method of any of aspects 14 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database, or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive, from a base station, control signaling comprising an indication of a configuration for a coexistence of resources used for a first radio access technology and a second radio access technology, wherein the UE operates in accordance with the first radio access technology;
perform, during a measurement period, a measurement of a control channel of the second radio access technology in response to the receiving; and
determine an initial partition of the resources based at least in part on the configuration and the measurement, wherein a first group of the initial partition of the resources is associated with the second radio access technology.

2. The apparatus of claim 1, wherein the instructions are further executable by the processor to cause the apparatus to:
decode a plurality of sidelink scheduling assignments associated with the second radio access technology during the measurement period; and
determine an updated partition of the resources based at least in part on the decoding.

3. The apparatus of claim 2, wherein the instructions are further executable by the processor to cause the apparatus to:
determine a first quantity of resources reserved for a first transmission of a plurality of transmissions, a second quantity of resources reserved for a future transmission of the plurality of transmissions, a priority of the plurality of transmissions, a reference signal received power associated with the control channel of the second radio access technology, or any combination thereof; and
determine the updated partition of the resources based at least in part on the determining.

4. The apparatus of claim 3, wherein the future transmission comprises a retransmission of the first transmission of the plurality of transmissions or semi-persistent scheduling resource signaling.

5. The apparatus of claim 3, wherein the instructions are further executable by the processor to cause the apparatus to:
filter the plurality of sidelink scheduling assignments based at least in part on the reference signal received power associated with the control channel of the second radio access technology, the priority of the plurality of transmissions, or any combination thereof.

6. The apparatus of claim 1, wherein the instructions to receive the control signaling are executable by the processor to cause the apparatus to:
receive the control signaling comprising an indication of the measurement period, a plurality of update periods after the measurement period, or a combination thereof.

7. The apparatus of claim 6, wherein the instructions are further executable by the processor to cause the apparatus to:
determine an updated partition of the resources according to a first update period of the plurality of update periods after the measurement period, wherein the updated partition of the resources is different from the initial partition of the resources.

8. The apparatus of claim 1, wherein the instructions to receive the control signaling are executable by the processor to cause the apparatus to:
receive the control signaling indicating at least one criterion for determining the initial partition of the resources by the UE.

9. The apparatus of claim 1, wherein the instructions are further executable by the processor to cause the apparatus to:
determine at least one criterion for determining the initial partition of the resources based at least in part on a signaling traffic pattern, a transmission statistic, or any combination thereof.

10. The apparatus of claim 1, wherein the instructions are further executable by the processor to cause the apparatus to:
determine a second group of the initial partition of the resources that is associated with the first radio access technology based at least in part on receiving the control signaling.

11. The apparatus of claim 1, wherein the instructions to receive the control signaling are executable by the processor to cause the apparatus to:
receive the control signaling comprising an indication of the second group of the initial partition of the resources that is associated with the first radio access technology.

12. The apparatus of claim 1, wherein the control channel of the second radio access technology comprises a sidelink control channel.

13. The apparatus of claim 1, wherein the first radio access technology comprises fifth generation New Radio and the second radio access technology comprises Long-Term Evolution.

14. An apparatus for wireless communication at a base station, comprising:
a processor;
memory coupled with the processor; and
instructions stored in the memory and executable by the processor to cause the apparatus to:
establish communications with a user equipment (UE) using a first radio access technology; and
transmit, to the UE, control signaling comprising an indication of a configuration for a coexistence of resources used for the first radio access technology and a second radio access technology, wherein the UE operates in accordance with the first radio access technology.

15. The apparatus of claim 14, wherein the instructions to transmit the control signaling are executable by the processor to cause the apparatus to:
transmit the control signaling comprising an indication of a measurement period, a plurality of update periods after the measurement period, or a combination thereof.

16. The apparatus of claim 14, wherein the instructions to transmit the control signaling are executable by the processor to cause the apparatus to:
transmit the control signaling indicating at least one criterion for determining an initial partition of the resources by the UE.

17. The apparatus of claim 14, wherein the instructions to transmit the control signaling are executable by the processor to cause the apparatus to:
transmit the control signaling comprising an indication of a first group of an initial partition of the resources associated with the second radio access technology and a second group of the initial partition of the resources associated with the first radio access technology.

18. The apparatus of claim 14, wherein the first radio access technology comprises fifth generation New Radio and the second radio access technology comprises Long-Term Evolution.

19. A method for wireless communication at a user equipment (UE), comprising:
receiving, from a base station, control signaling comprising an indication of a configuration for a coexistence of resources used for a first radio access technology and a second radio access technology, wherein the UE operates in accordance with the first radio access technology;
performing, during a measurement period, a measurement of a control channel of the second radio access technology in response to the receiving; and
determining an initial partition of the resources based at least in part on the configuration and the measurement, wherein a first group of the initial partition of the resources is associated with the second radio access technology.

20. The method of claim 19, further comprising:
decoding a plurality of sidelink scheduling assignments associated with the second radio access technology during the measurement period; and
determining an updated partition of the resources based at least in part on the decoding.

21. The method of claim 20, further comprising:
determining a first quantity of resources reserved for a first transmission of a plurality of transmissions, a second quantity of resources reserved for a future transmission of the plurality of transmissions, a priority of the plurality of transmissions, a reference signal received power associated with the control channel of the second radio access technology, or any combination thereof; and
determining the updated partition of the resources based at least in part on the determining.

22. The method of claim 21, wherein the future transmission comprises a retransmission of the first transmission of the plurality of transmissions or semi-persistent scheduling resource signaling.

23. The method of claim 21, further comprising:
filtering the plurality of sidelink scheduling assignments based at least in part on the reference signal received power associated with the control channel of the second radio access technology, the priority of the plurality of transmissions, or any combination thereof.

24. The method of claim 19, wherein receiving the control signaling comprises:
receiving the control signaling comprising an indication of the measurement period, a plurality of update periods after the measurement period, or a combination thereof.

25. The method of claim 24, further comprising:
determining an updated partition of the resources according to a first update period of the plurality of update periods after the measurement period, wherein the updated partition of the resources is different from the initial partition of the resources.

26. The method of claim 19, wherein receiving the control signaling comprises:
receiving the control signaling indicating at least one criterion for determining the initial partition of the resources by the UE.

27. The method of claim 19, further comprising:
determining at least one criterion for determining the initial partition of the resources based at least in part on a signaling traffic pattern, a transmission statistic, or any combination thereof.

28. The method of claim 19, further comprising:
determining a second group of the initial partition of the resources that is associated with the first radio access technology based at least in part on receiving the control signaling.

29. The method of claim 19, wherein receiving the control signaling comprises:
receiving the control signaling comprising an indication of the second group of the initial partition of the resources that is associated with the first radio access technology.

30. A method for wireless communication at a base station, comprising:
establishing communications with a user equipment (UE) using a first radio access technology; and
transmitting, to the UE, control signaling comprising an indication of a configuration for a coexistence of resources used for the first radio access technology and a second radio access technology, wherein the UE operates in accordance with the first radio access technology.
